(19) United States
(12) Patent Application Publication
(10) Pub. No.: US 2019/0068477 A1
(43) Pub. Date: Feb. 28, 2019

(54) COMMUNICATION POLLING AND ANALYTICS

(71) Applicant: Microsoft Technology Licensing, LLC, Redmond, WA (US)

(72) Inventor: Jason FAULKNER, Seattle, WA (US)

(73) Assignee: Microsoft Technology Licensing, LLC, Redmond, WA (US)

(21) Appl. No.: 15/687,204

(22) Filed: Aug. 25, 2017

(51) Int. Cl. H04L 12/26; H04L 12/58; H04L 12/24; H04L 29/08

(52) U.S. Cl. CPC H04L 43/10; H04L 51/16; H04L 67/14; H04L 41/046; H04L 41/142

(57) ABSTRACT

Examples of the present disclosure describe systems and methods for communication polling and analytics. In an example, users may communicate during a communication session. For example, users may communicate via an electronic communication platform or via real-world communication, or any combination thereof. A transcript may be generated, wherein the transcript may comprise information relating to user actions during the communication session. In another example, users may be polled to request additional information for inclusion in the transcript. In some examples, a user may be absent while other users communicate. Accordingly, the transcript associated with the communication session may be used to generate analytics, such as an activity summary, user engagement statistics, or a project status or progress report, among other examples. The analytics may be reviewed in order to determine what occurred while the user was absent without requiring the user to thoroughly review the transcript of the communication session.

### BACKGROUND

During a communication session among a plurality of users, users may exchange messages and/or perform a variety of other actions. However, it may be difficult for a user that is not contemporaneously engaged with the communication session to later review or analyze the actions of other users of the communication session.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for communication polling and analytics. In an example, users may communicate with one another during a communication session. For example, a user may use a user device to communicate with other users via an electronic communication platform, or one or more users may engage in real-world communication, or any combination thereof. A transcript may be generated for the communication session, wherein the transcript may comprise entries for user actions performed by users during the communication session. As an example, the transcript may comprise messages, shared document revisions, and user presence information. Users may be polled during the communication session in order to receive additional information that may be incorporated into the transcript for the communication session.

In some examples, a user may be absent from a communication session while other users may be communicating. For example, the user may be located in a different time zone and may therefore have different working hours. As another example, a user may be a supervisor of other users of the communication session, such that the user may only occasionally be present in the communication session. Thus, according to aspects disclosed herein, the transcript associated with the communication session may be analyzed in order to generate analytics, such as an activity summary, user engagement statistics, or a project status or progress report, among other examples. The generated analytics may be reviewed by a user in order to determine what occurred while the user was absent without requiring the user to thoroughly review the transcript of the communication session.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for communication polling and analytics.

FIG. 2 illustrates an overview of an example graph with which aspects disclosed herein may be practiced.

FIG. 3 illustrates an overview of an example method for processing a user action during a communication session.

FIG. 4 illustrates an overview of an example method for generating a poll for a communication session.

FIG. 5A illustrates an overview of an example method for performing analysis of a communication session transcript.

FIG. 5B illustrates an overview of an example method for performing an analysis based on relevant information for a communication session.

FIG. 6 is a block diagram illustrating example physical components of a computing device with which aspects of the disclosure may be practiced.

FIG. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, a user of an electronic communication platform may communicate with other users during a communication session. Users may exchange electronic messages, engage in audio and/or video calls, or participate in collaborative editing of a shared document using the electronic communication platform, among other actions. However, not all users may be contemporaneously engaged during the communication session. For example, a user may be in a different time zone with different working hours, may have a conflicting meeting, or may be a supervisor that only occasionally engages with the communication session. In some examples, an absent user may review a transcript of the communication session, attempt to identify changes in a shared document, or ask another user for a summary of what occurred while the user was absent. However, such techniques may be time-consuming and onerous, which may negatively impact productivity and increase the difficulty with which the users collaborate and communicate.

Accordingly, the present disclosure provides systems and methods for communication polling and analytics. In an example, a transcript may be used to collect and store information associated with a communication session. The transcript may be analyzed in order to generate analytics, such as an activity summary, user engagement statistics, or a project status or progress report, among other examples. In another example, the analysis may comprise analyzing information external to the transcript or external information may be incorporated into the transcript, or any combination thereof. In some examples, one or more users of the communication session may be polled in order to collect additional information from the users. For example, users may be polled periodically or in response to determining certain criteria are met. Information received in response to polling may be stored as part of the transcript, and may be used for subsequent analysis according to aspects disclosed herein.

A communication session may be between multiple users, wherein the users may exchange messages, engage in audio and/or video calls, or participate in collaborative editing of a shared document, among other actions. Such actions may occur as part of a communication session, even though one or more users may be absent from the communication session. For example, a communication session may be a conversation channel or chat room, wherein a present user may perform actions (e.g., send messages, edit a shared document, etc.), while a user that is contemporaneously absent from the communication session may later access the channel to view and/or interact with the then-present user's actions. Thus, a communication session may have a varying number of present users and, in some examples, may have no present users (e.g., all users may be absent or offline, etc.). Further, membership of a communication session may change, such that users may be added or removed without requiring the creation of a new communication session. While example communication sessions and actions are discussed herein, it will be appreciated that any of a variety of other types of communication sessions and/or actions may be used.

In an example, a communication session may comprise one or more audio and/or video calls or electronic messages, or may enable users to engage in shared document collaboration, among other actions. In another example, a communication session may comprise an in-person meeting, a virtual meeting, a meeting where one or more attendees are present via telepresence, or any combination thereof. In an example where at least a part of the communication session comprises real-world actions, one or more sensors and/or devices may be used to generate information or capture sensor input that may be added to a transcript of the communication session. For example, facial recognition may be performed by a video or still camera in order to determine the attendees of an in-person meeting. In another example, one or more microphones may be used to record audio, which may be stored and/or used to generate a speech recognition result.

As such, a transcript for a communication session may not only contain entries relating to electronic actions, but may contain entries relating to real-world actions. For example, a transcript may contain messages, conversation transcriptions, screen captures, document versions or revisions, timestamp information (e.g., when a user joined and left, when messages were sent, when the communication session had no users, etc.), facial recognition results, audio and/or video recordings, drawings (e.g., as may be captured from a whiteboard, scanned documents, etc.), etc. It will be appreciated that while example electronic and real-world actions are discussed herein, other actions may be used without departing from the spirit of this disclosure.

In examples, a transcript for a communication session may comprise external information, including, but not limited to, information from another data store (e.g., a graph or relational database, a storage device, etc.), from an external service (e.g., a collaboration platform, a social network, a unified graph, etc.), publicly available information (e.g., census data, weather forecasts, etc.), or from a software application (e.g., a document editor, a note-taking application, etc.). In an example, external information may be user-generated, programmatically-generated, generated based on machine learning, or comprise real-world observations. For example, the transcript may comprise weather information for a day of a scheduled meeting, so as to provide additional context as to why meeting attendance may have been low. While example external information is described herein, it will be appreciated that other external information may be used.

One or more users of a communication session may be polled in order to determine or request additional information. In some examples, polling may occur periodically (e.g., daily or weekly, after a certain number of messages have been sent, when a specific subset of users is present, etc.) or may occur when one or more criteria are satisfied. As an example, a supervisor may indicate that users should be polled every Friday in order to determine the current status of a project. In another example, polling may be tied to a workflow. For example, polling may occur based on progress in a shared document (e.g., upon reviewing and incorporating changes, upon completing an updated draft, etc.). Information received as a result of polling may be processed and stored as part of the transcript for the communication session. For example, the information may be viewed as part of the transcript or may be analyzed according to aspects disclosed herein. In another example, a transcript may be modified directly in order to add, modify, and/or remove information.

A transcript of a communication session may be analyzed in order to generate information relating to the communication session. In some examples, a statistical analysis may be performed to determine user engagement statistics (e.g., presence information, attendance frequency, average conversation length, typical actions performed by users, etc.) or to generate comparison information as compared to a similar communication session (e.g., based on similar users, a similar project, similar subject matter, etc.) or to a statistical model, among other analyses. In other examples, the analysis may be rule-based, wherein one or more rules may be evaluated in order to generate a summary of at least part of the transcript. For example, a rule may indicate that document revisions and related comments from a transcript should be identified and included in a summary of the transcript. In an example, the rule may further indicate that additional processing should occur, such as accessing a revised portion of the document and generating a comparison between the current document and the previous document. In examples, rules may be user configurable and/or programmatically generated. In another example, machine learning may be used to generate a summary of at least part of the transcript. Relevant messages or parts of messages may be identified and included in the summary, such that an absent user may receive the summary and easily determine what occurred while the user was absent. While example analysis techniques are discussed herein, it will be appreciated that any of a variety of analysis techniques maybe used.

In some examples, the transcript may comprise external information. In other examples, analyzing the transcript may comprise accessing external information from a location other than the transcript. As a result, additional context may be used as part of the analysis, thereby improving the quality of the analysis. For example, an organizational chart may be accessed to determine the role of one or more users of a communication session, which may be used when summarizing at least a part of the transcript. In another example, calendar information for one or more users may be accessed in order to determine a convenient time to schedule a subsequent meeting. In other examples, external information may comprise audio data, image recognition data, or other sensor information which may be stored by a computing device or service. This, while at least a part of the sensor information may be incorporated into a transcript according to aspects described herein, additional and/or alternative sensor information may be available as external information. Accordingly, even if real-world interactions are not incorporated into the transcript, they may still be available as external information.

In an example, external information may comprise information from a unified graph, wherein the graph may comprise nodes and relationships relating to a variety of topics, domains, services, and/or users. For example, a node may be a document, information relating to a document (e.g., a revision, a comment or annotation, metadata, properties, etc.), a message, a conversation, a presence update or indication, a calendar event, a user node comprising information relating to a user (e.g., a username, a user identity, an email address, a phone number, etc.), among others. A document may contain any kind of information, including, but not limited to, text data, image or video data, audio data, drawings, simulations, 3D models, cryptographic keys, shared secrets, calculations, algorithms, recipes, formulas, or any combination thereof. Nodes of the unified graph may be associated by one or more relationships, thereby indicating a correlation between two or more nodes of the unified graph.

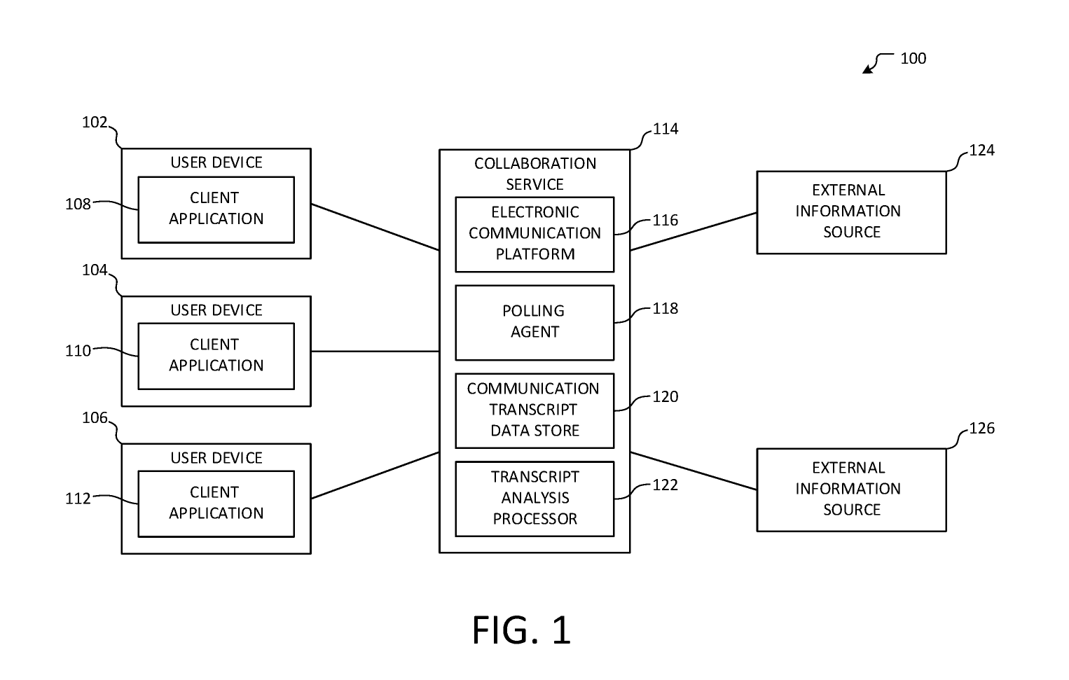

FIG. 1 illustrates an overview an example system 100 for communication polling and analytics. As illustrated, system 100 comprises user devices 102-106,collaboration service 114, and external information sources 124-126. Users of user devices 102-106 may collaborate with one another according to aspects disclosed herein using collaboration service 114. For example, client applications 108-112 may be used to send and receive electronic messages, engage in audio/video calls, and draft or revise shared documents, among other actions. In some examples, collaboration service 114 may be a cloud-based service (e.g., MICROSOFT OFFICE 365, GOOGLE G SUITE, etc.), or may be a remotely and/or locally hosted service, or any combination thereof. In other examples, external information sources 124-126 may each comprise external information according to aspects disclosed herein. External information may be accessed from external information source 124 and/or 126 and used when analyzing a transcript and/or generating a poll, among other examples. External information source 124 and/or 126 may comprise a social network, public information, a unified graph, or a data store, among other information.

User devices 102-106 may be any of a variety of computing devices, including, but not limited to, mobile computing devices, tablet computing devices, laptop computing devices, or desktop computing devices, or any combination thereof. Client applications 108-112 may be any of a variety of applications, including, but not limited to, web-based applications, native applications, hybrid applications, or integrated operating system functionality, or any combination thereof. It will be appreciated that other user devices and/or client applications may be used. Further, while only one client application is illustrated for each of user devices 102-106, it will be appreciated that any number of client applications may be used by a user of a user device to interact with collaboration service 114.

Collaboration service 114 is comprised of electronic communication platform 116, polling agent 118, communication transcript data store 120, and transcript analysis processor 122. It will be appreciated that elements 116-122 of collaboration service 114 are provided as an example, and other examples may comprise fewer, additional, or different elements that perform various aspects as described herein. Electronic communication platform 116 may enable users of user devices 102-106 to collaborate with one another using client applications 108-112. As described herein, electronic communication platform 116 may enable users to send messages, engage in audio/video calls, or participate in collaborative editing of a shared document, among other actions. Users may communicate using electronic communication platform 116 as part of a communication session.

During a communication session, polling agent 118 may generate a poll, which may be provided to one or more of client applications 108-112 for display to a respective user. In an example, the poll may be generated occasionally, or may be generated based upon determining that one or more criteria are satisfied. For example, polling agent 118 may generate a poll every morning, when a user engages with the communication session, or when a milestone or goal is achieved. In some examples, polling agent 118 may use information from communication transcript data store 120, external information source 124, and/or external information source 126. Input for the poll may be received by one or more of client applications 108-112, which may be provided to polling agent 118. Polling agent 118 may process the received responses (e.g., determine an average or a majority, communicate one or more received results or a summary of the received results to a recipient such as a supervisor, generate a summary of the received results, etc.), which may be stored as part of a transcript associated with the communication session in communication transcript data store 120.

Communication transcript data store 120 may store one or more transcripts for a communication session of collaboration service 114. In some examples, communication transcript data store 120 may store transcripts for multiple communication sessions. In an example, communication transcript data store 120 may be a data store that is local (e.g., as a local storage device, a local data base, etc.) to collaboration service 114, while in another example communication transcript data store 120 may be stored remotely (e.g., as a remote storage device, a networked storage device, a remote data base, etc.), or any combination thereof. In an example, communication transcript data store 120 may comprise external information (e.g., information external to a communication session), which may be received from external information source 124 and/or 126. In other examples, a transcript may be stored as nodes and relationships as part of a graph database. For example, information associated with user actions during a communication session may be used to generate nodes in the graph database, which may be stored and associated with other nodes (e.g., other user actions, user nodes, etc.) by one or more relationships. In examples, one or more tables of a relational database may be used. While example storage techniques are described herein, it will be appreciated that a transcript may be stored using a wide variety of techniques and data structures.

Transcript analysis processor 122 may analyze a transcript associated with a communication session (e.g., as may be stored by communication transcript data store 120). For example, transcript analysis processor 122 may perform a statistical analysis, a rule-based analysis, or use machine learning in order to generate a statistical report, identify relevant information, or generate a summary of the transcript. In an example, transcript analysis processor 122 may evaluate external information, which may be stored by communication transcript data store 120 or accessed from external information source 124 and/or 126, according to aspects disclosed herein. In some examples, a combination of techniques may be used. A user may request that transcript analysis processor 122 perform an analysis of at least a part of a communication session transcript, or the analysis may be performed automatically. In some examples, an electronic conversation agent may be part of a communication session, such that transcript analysis processor 122 may provide analysis via the electronic conversation agent to the communication session. In other examples, users may interact with the electronic conversation agent in order to request that transcript analysis processor 122 perform analysis. It will be appreciated that other analysis techniques may be used without departing from the spirit of this disclosure.

While system 100 is described herein with respect to electronic communications, it will be appreciated that collaboration service 114 may gather information relating to real-world communications. For example, collaboration service 114 may use sensors (e.g., motion sensors, microphones, image and/or video cameras, etc.) and/or devices in order to generate or capture information that may be added to a transcript for a communication session (e.g., stored by communication transcript data store 120). Thus, information relating to a real-world meeting of users relating to a communication session of collaboration service 114 may be stored by a transcript associated with the communication session, thereby enabling the information to be processed by transcript analysis processor 122.

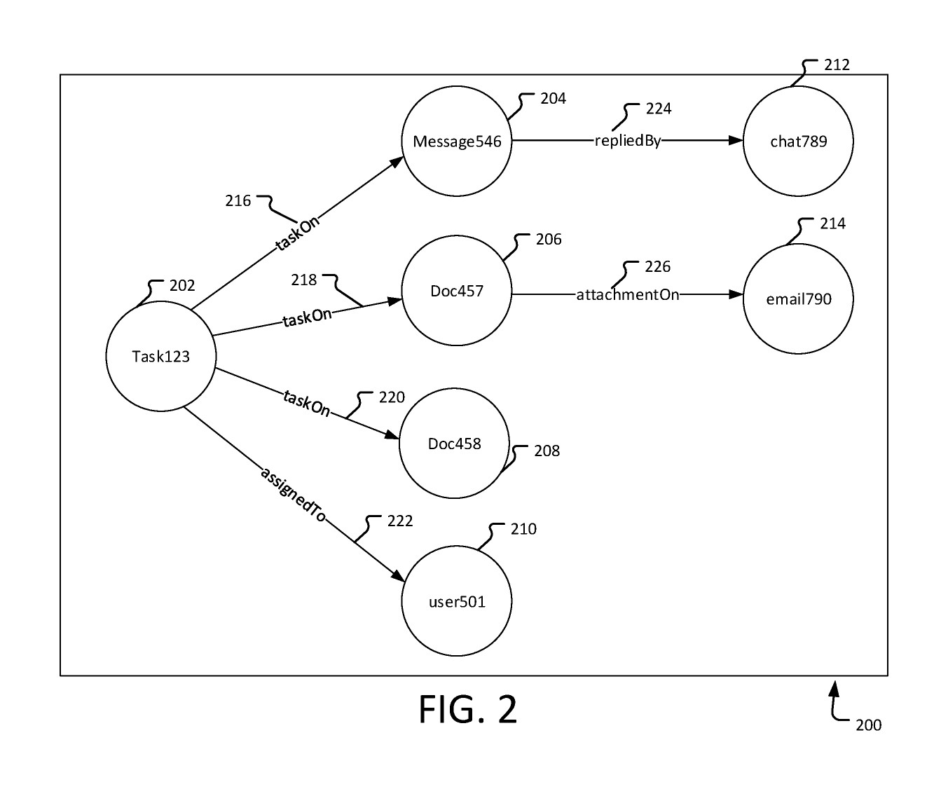

FIG. 2 illustrates an overview of an example graph 200 with which aspects disclosed herein may be practiced. In an example, example graph 200 may comprise information relating to a communication session (e.g., at least a part of a transcript), as well as external information. Example graph 200 comprises nodes 202, 204, 206, 208, 210, 212, and 214, and relationships 216, 218, 220, 222, 224, and 226. In aspects, graph 200 may be generated and/or manipulated by one or more services, users, and/or computing devices. For example, graph 200 may be a unified graph comprising nodes and relationships relating to a variety of topics, domains, services, and/or users. The nodes and relationships may also be generated by an external bot or application created by a developer. For instance, an add-in may be programmed to monitor activity in a browser or other application to track usage of the application. Based on the usage of the application, the add-in may send additional nodes and relationships to be included in graph 200.

Graph 200 further depicts that node 202 is associated with nodes 206, 208, and 210. As an example, graph 200 may illustrate that node 202 represents a task to be performed based on the completion of nodes 206 and 208, as illustrated by relationships 218 and 220. Node 210 may indicate that the task is assigned to user 501, represented by node 210, which is associated with node 202 by “assignedTo” relationship 222. Graph 200 may also comprise aspects of an example transcript, as illustrated by nodes 204 and 212 relating to a communication session. Nodes 204 and 212 are associated by relationship 224, thereby indicating that node 212 (i.e., chat789) is a reply to node 204 (i.e., message546). While specific types of nodes and relationships are described in FIG. 2, it will appreciated that other types of nodes and/or relationships may be included in a graph without departing from the spirit of this disclosure.

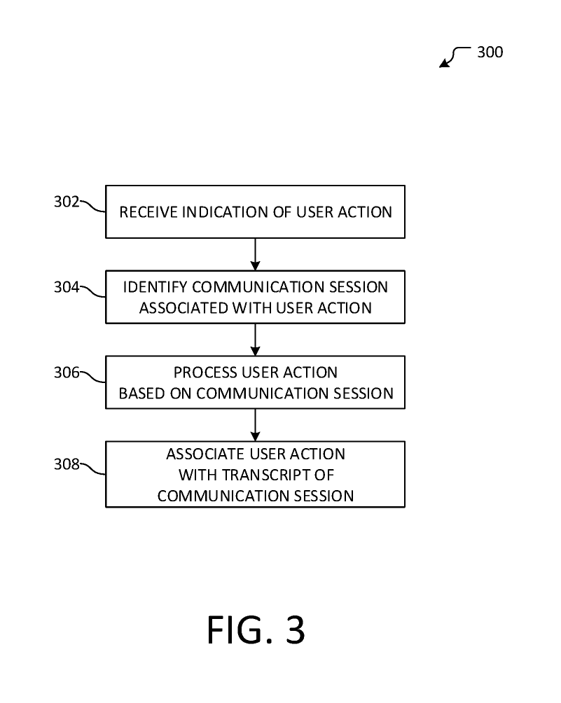

FIG. 3 illustrates an overview of an example method 300 for processing a user action during a communication session. In an example, method 300 may be performed by one or more computing devices. In some examples, method 300 may be performed by collaboration service 114 in FIG. 1. Method 300 begins at operation 302, where an indication of a user action may be received. In an example, the indication may be received as a result of a user sending an electronic message during a communication session (e.g., via electronic communication platform 116 in FIG. 1). In another example, the indication may be received from a sensor as a result of a real-world action by the user. In some examples, the indication may be received from a collaboration service such as collaboration service 114 in FIG. 1. In other examples, the indication may be received from a third party application or service via an application programming interface (API) or webhook callback. It will be appreciated that the indication may be received as a result of a variety of user actions and from a wide array of sources.

Moving to operation 304, a communication session associated with the user action may be identified. In an example, identifying the communication session may comprise evaluating a part of the indication received at operation 302. For example, the indication may comprise a communication session identifier or a listing of one or more users and/or user devices of the communication session, etc. At least part of the indication may be evaluated using matching logic (e.g., a communication session associated with a communication session identifier may be identified or a communication session having a similar subset of users may be determined, etc.). The communication session may be identified based on a transcript in a data store, such as communication transcript data store 120 in FIG. 1.

At operation 306, the user action may be processed based on the identified communication session. In an example, processing the user action may comprise determining whether polling should be initiated (e.g., as may be performed by polling agent 118 in FIG. 1). In another example, the user action may be evaluated in order to determine whether analysis should be performed (e.g., as may be performed by transcript analysis processor 122 in FIG. 1). For example, criteria may be evaluated, which, when determined to be satisfied, may cause the user action to be included as part of a transcript analysis according to aspects disclosed herein. Thus, in an example, transcript analysis may occur in response to user actions, user requests, and/or periodically.

Moving to operation 308, the user action may be associated with a transcript of the communication session. In an example, the transcript may be stored by communication transcript data store 120 in FIG. 1. In an example where the transcript is a graph database, associating the user action with the transcript may comprise generating a node associated with the user action and associating the generated node with one or more other nodes of the transcript. In another example, the user action may be stored in a relational database associated with the communication session. In some examples, the transcript may be located based on a communication session identifier received at operation 302 or based on the identified communication session at operation 304. It will be appreciated that a user action may be stored using any of a variety of techniques. Flow terminates at operation 308.

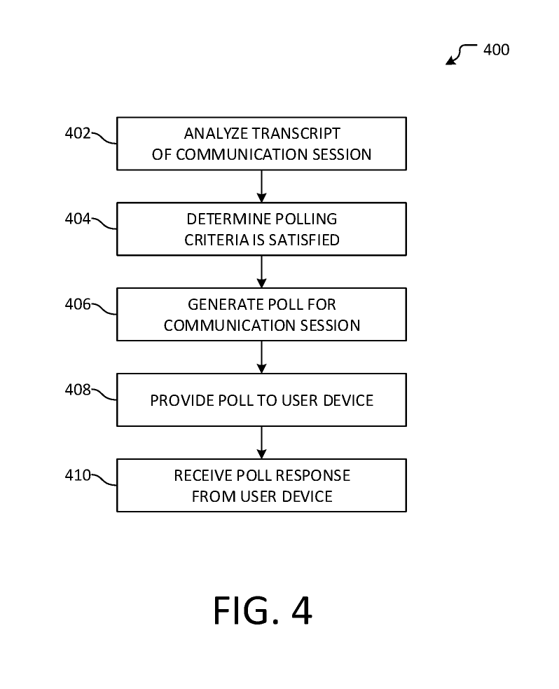

FIG. 4 illustrates an overview of an example method 400 for generating a poll for a communication session. In an example, method 400 may be performed by one or more computing devices. In another example, method 400 may be performed by polling agent 118 in FIG. 1. Method 400 begins at operation 402, where a transcript associated with a communication session may be analyzed. In some examples, the analysis may be performed periodically or may be in response to a request from a user. The analysis may comprise evaluating a subpart of the transcript, such as information relating to a specific time period (e.g., the past day, past week, etc.), information relating to an exchange between a subset of users, or information relating to a specific shared document, among other information. In other examples, the analysis may comprise evaluating external information, according to aspects described herein. In another example, the analysis may comprise an evaluation of one or more predicted actions, which may be determined based on the transcript and/or external information. In an example, a predicted action may be received from an external service, such as external information service 124 or 126 in FIG. 1.

Moving to operation 404, one or more criteria may be used to determine whether the analysis satisfies the criteria. As an example, criteria may be satisfied when a subset of users mark a draft as final or based on user attendance during a communication session. While method 400 is discussed with respect to polling based on an evaluation of a communication session transcript using criteria, other examples with one or more similar operations may comprise polling based on a predetermined interval or in response to a user request, among other triggers.

At operation 406, a poll may be generated for the communication session. In an example, the poll may be generated based on information associated with the criteria, such as a type of poll or content for the poll. In another example, the poll may be generated based on the analysis of the transcript performed and/or external information at operation 402. For example, it may be determined that a new version of a shared document has been created by users of the communication session. As a result, a poll may be generated to request the current status of the shared document (e.g., whether the document should be finalized, whether subsequent revisions are necessary, whether another reviewer should review the shared document, etc.). In some examples, machine learning techniques may be used to generate a poll, wherein a classifier may be trained based on training communication sessions and associated example polling questions, such that the classifier may be used to classify and generate relevant polls based on subsequent communication sessions. It will be appreciated that a variety of other techniques may be used to generate a poll for the communication session.

Flow progresses to operation 408, where the poll may be provided to a user device. In some examples, the poll may be provided to multiple user devices (e.g., all or a subset of users of the communication session). In an example, providing the poll to the user device may comprise providing the poll as a message of the communication session (e.g., via an electronic communication agent, as a system message from the collaboration service, etc.). In another example, the poll may be provided to the user device outside of the communication session (e.g., as an electronic message to an inbox of a user of the user device, as a voice call to a mobile device of the user, etc.). A variety of techniques may be used to provide the poll to one or more user devices without departing from the spirit of this disclosure.

At operation 410, a poll response may be received from the user device. In an example, the response may be received using a similar communication technique as was used to provide the poll to the user device at operation 408 (e.g., the user may respond to the electronic communication agent or may reply to an electronic message, etc.). In another example, a different communication technique may be used to receive the poll response from the user device. For example, if an electronic message is provided to an inbox of a user, the user may use a uniform resource identifier, globally unique identifier, or other resource identifier to access a webpage using the user device in order to provide the poll response. In examples, automated speech recognition may be used to interpret a poll response that is received as a speech utterance. Any of a variety of techniques may be used to receive the poll response. Flow terminates at operation 410.

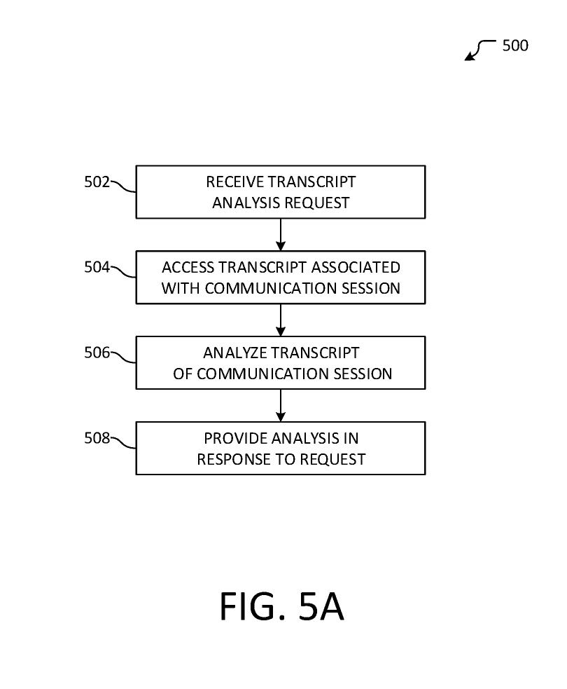

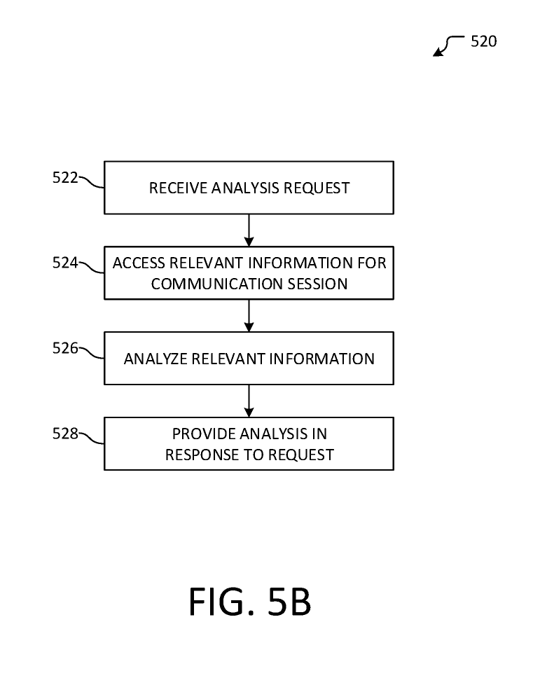

FIG. 5A illustrates an overview of an example method 500 for performing analysis of a communication session transcript. In an example, method 500 may be performed by one or more computing devices. In another example, method 500 may be performed by transcript analysis processor 122 in FIG. 1. Method 500 begins at operation 502, where a transcript analysis request may be received. The request may be received from a user device of a communication session, or may be generated periodically (e.g., daily, weekly, etc.) or based on determining one or more criteria are satisfied (e.g., a user has joined a communication session, a subset of users have engaged in communication, etc.). The request may be received as a message from a user device or as a result of a user interacting with a user interface element on the user's device, among other sources.

Flow progresses to operation 504, where a transcript associated with a communication session may be accessed. In an example, the request received at operation 502 may comprise an indication relating to a communication session and/or a transcript. The indication may be used to determine how to access the transcript (e.g., a server device, a node in a graph database, a table in a relational database, etc.). In another example, the transcript may be accessed based on the user device from which the request was received (e.g., based on an analysis of the communication sessions with which the user device is associated or information associated with a user of the user device, etc.).

At operation 506, the transcript may be analyzed. In some examples, a subpart of the transcript may be analyzed, such as a subpart of the transcript relating to a specific time period or comprising interactions of a subset of users. The transcript analysis request received at operation 502 may comprise an indication as to the type and/or scope of the analysis, as well as the type of output, among other indications.

In an example, the analysis may comprise statistical analysis in order to determine user engagement statistics (e.g., presence information, attendance frequency, average conversation length, typical actions performed by users, etc.) or to generate comparison information as compared to a similar communication session or to a statistical model, among other analyses. In another example, the analysis may be rule-based, wherein one or more rules may be evaluated in order to generate a summary of at least part of the transcript. For example, a rule may indicate that document revisions and comments from a transcript should be identified and included in a summary of the transcript. In an example, the rule may further indicate that additional processing should occur, such as accessing a revised portion of the document and generating a comparison between the current document and the previous document. In other examples, rules may be user configurable and/or programmatically generated. In examples, machine learning may be used to generate a summary of at least part of the transcript. Relevant messages or parts of messages may be identified and included in the summary, such that an absent user may receive the summary and easily determine what occurred while the user was absent. It will be appreciated that any of a variety of other analysis techniques maybe used.

Moving to operation 508, the generated analysis may be provided in response to the analysis request. In an example, providing the analysis may comprise generating an informational graphic comprising information relating to a statistical analysis. In another example, an electronic conversation agent may be used to communicate summary information or other analysis in response to the received transcript analysis request. In some examples, the analysis may be provided as part of a shared document (e.g., as one or more comments or revisions, etc.). The generated analysis may be provided using any of a variety of other techniques. Flow terminates at operation 508.

FIG. 5B illustrates an overview of an example method 520 for performing analysis based on relevant information for a communication session. In an example, method 520 may be performed by one or more computing devices. In another example, method 520 may be performed by transcript analysis processor 122 in FIG. 1. Method 520 begins at operation 522, where an analysis request may be received. The request may be received from a user device of a communication session, or may be generated periodically (e.g., daily, weekly, etc.) or based on determining one or more criteria are satisfied (e.g., a user has joined a communication session, a subset of users have engaged in communication, etc.). The request may be received as a message from a user device or as a result of a user interacting with a user interface element on the user's device, among other sources.

Flow progresses to operation 524, where relevant information for a communication session may be accessed. In an example, relevant information may comprise at least part of a transcript for the communication session. In another example, relevant information may comprise external information, as may be stored by a communication session transcript or may be available from an external information source, such as external information source 124 and/or 126 in FIG. 1. In some examples, the indication may provide an indication as to the relevant information to access (e.g., based on a date range, external information source, etc.).

At operation 526, the relevant information may be analyzed. In some examples, a subpart of the relevant information may be analyzed, such as relevant information relating to a specific time period or relating to interactions of a subset of users. In other examples, the analysis may comprise accessing additional information (e.g., from an external information source, from a transcript, etc.) as part of the analysis. The analysis request received at operation 502 may comprise an indication as to the type and/or scope of the analysis, as well as the type of output, among other indications.

In an example, the analysis may comprise statistical analysis in order to determine user engagement statistics (e.g., presence information, attendance frequency, average conversation length, typical actions performed by users, etc.) or to generate comparison information as compared to a similar communication session or to a statistical model, among other analyses. In another example, the analysis may be rule-based, wherein one or more rules may be evaluated in order to generate a summary of at least part of the transcript. For example, a rule may indicate that document revisions and comments from a transcript should be identified and included in a summary of the transcript. In an example, the rule may further indicate that additional processing should occur, such as accessing a revised portion of the document and generating a comparison between the current document and the previous document. In other examples, rules may be user configurable and/or programmatically generated. In examples, machine learning may be used to generate a summary of at least part of the transcript. Relevant messages or parts of messages may be identified and included in the summary, such that an absent user may receive the summary and easily determine what occurred while the user was absent. It will be appreciated that any of a variety of other analysis techniques maybe used.

Moving to operation 528, the generated analysis may be provided in response to the analysis request. In an example, providing the analysis may comprise generating an informational graphic comprising information relating to a statistical analysis. In another example, an electronic conversation agent may be used to communicate summary information or other analysis in response to the received analysis request. In some examples, the analysis may be provided as part of a shared document (e.g., as one or more comments or revisions, etc.). The generated analysis may be provided using any of a variety of other techniques. Flow terminates at operation 528.

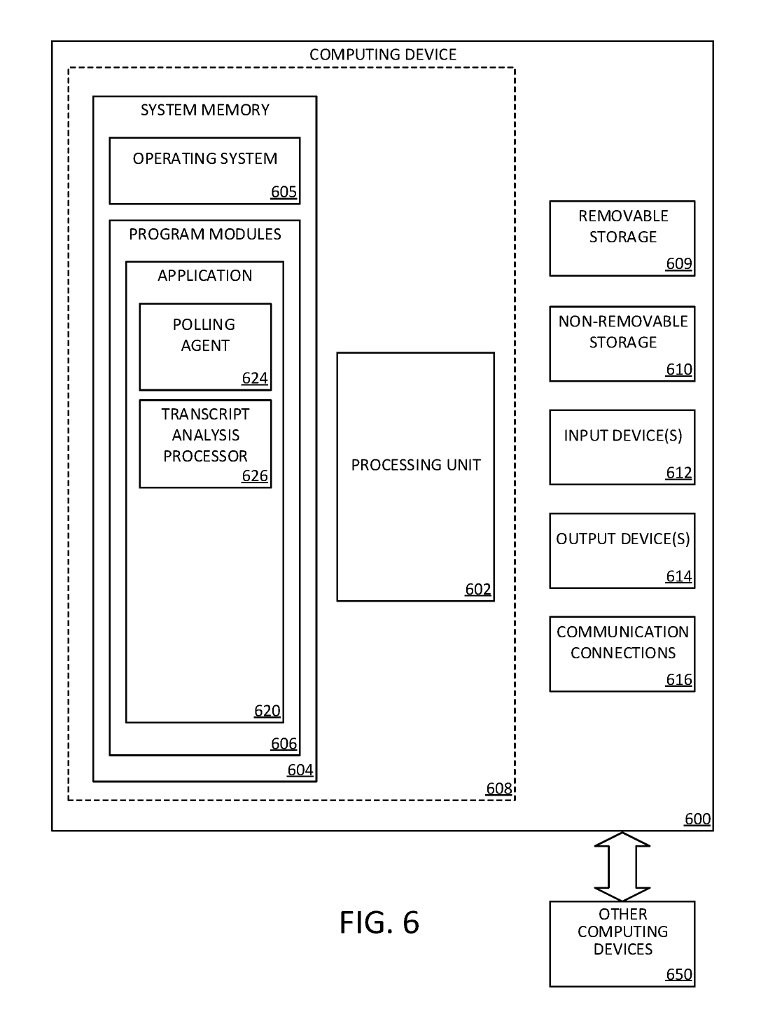

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for performing the various aspects disclosed herein such as polling agent 624 and transcript analysis processor 626. The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

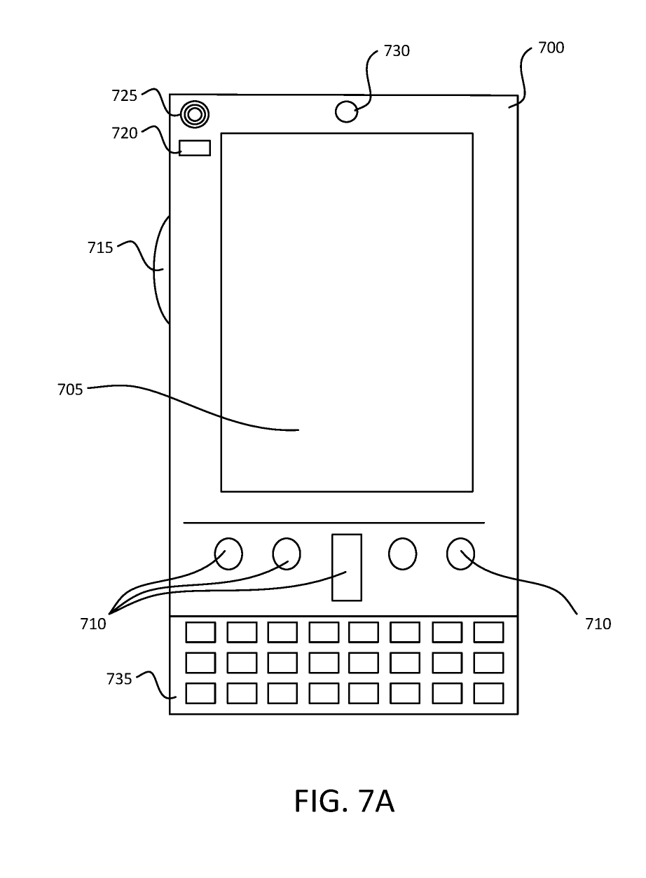

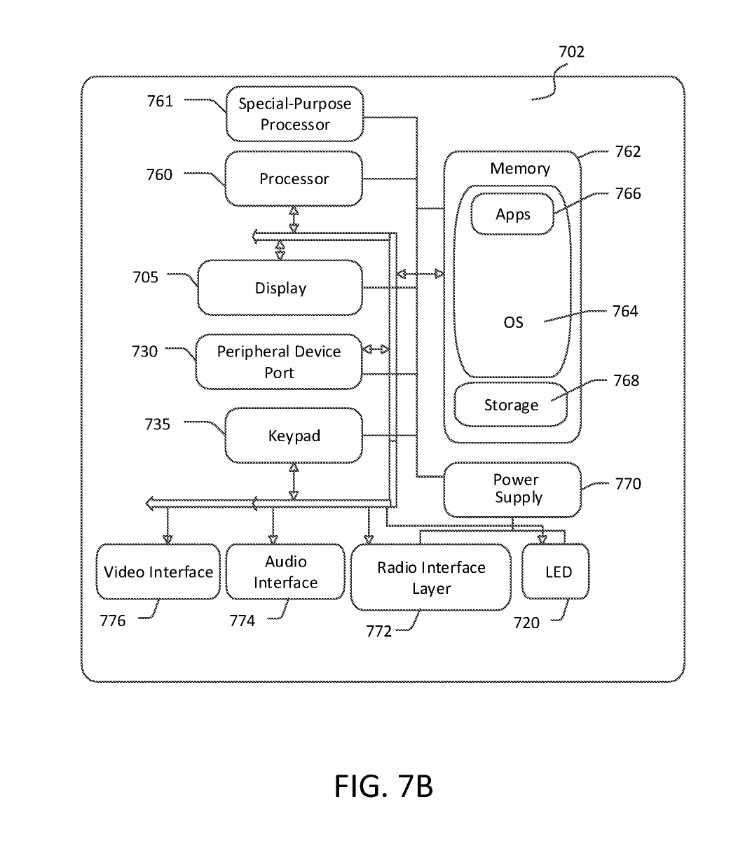

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein (e.g., search engine, extractor module, relevancy ranking module, answer scoring module, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

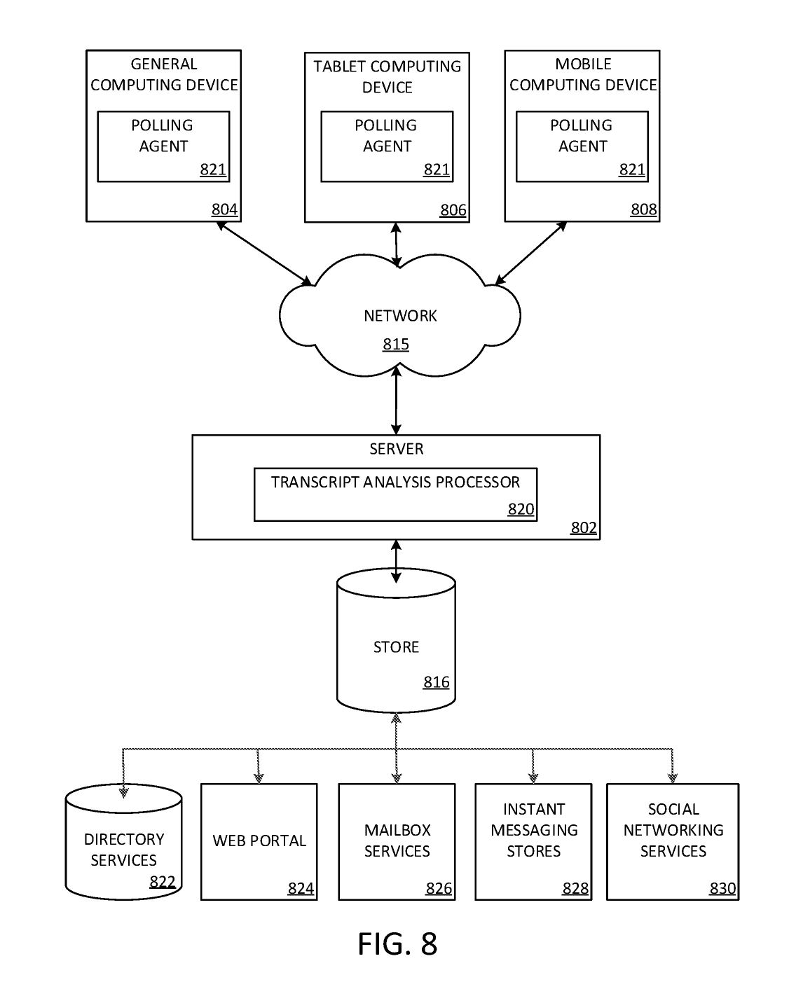

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 822, a web portal 824, a mailbox service 826, an instant messaging store 828, or a social networking site 830. Polling agent 821 may be employed by a client that communicates with server device 802, and/or transcript analysis processor 820 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these embodiments of the computing devices may obtain content from the store 816, in addition to receiving graphical data useable to be either pre-processed at a graphic-originating system, or post-processed at a receiving computing system.

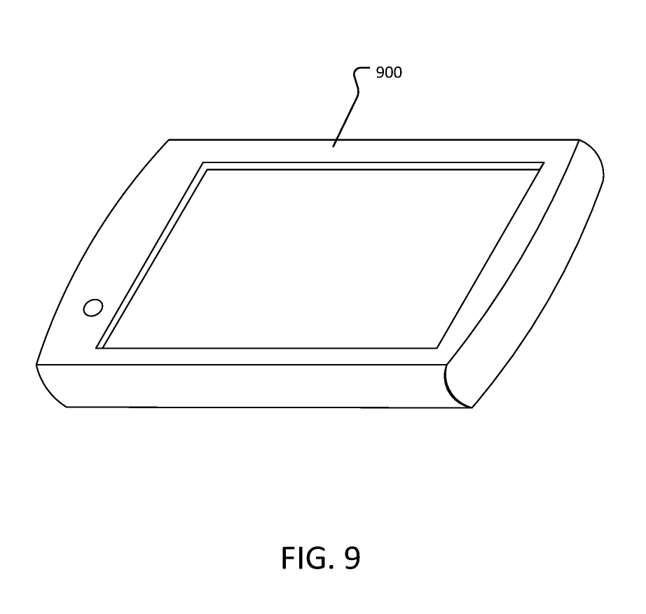

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: identifying, as part of a communication session, a user action from a first user device associated with the communication session; generating an entry in a transcript of the communication session based on the user action; receiving an analysis request from a second user device, wherein the analysis request comprises a request to analyze the transcript of the communication session; generating, based on the received analysis request, an analysis result for at least a part of the transcript of the communication session; and providing the analysis result as a response to the second user device. In an example, the first user device is a computing device, and wherein identifying the user action from the first user device comprises receiving an indication from the first user device of the user action. In another example, the first user device comprises a sensor, and wherein identifying the user action from the first user device comprises receiving an indication from the first user device of the user action based on sensor input received by the first user device from the sensor. In a further example, generating the entry in the transcript of the communication session comprises: accessing a graph database comprising one or more nodes associated with the communication session; generating a node based on the user action; and generating a relationship between the node and at least one of the one or more nodes. In yet another example, generating the analysis result comprises performing a statistical analysis for the at least part of the transcript. In a further still example, receiving the analysis request comprises receiving the analysis request by an electronic conversation agent of the communication session, and wherein the analysis result is provided by the electronic conversation agent. In another example, the set of operations further comprises: analyzing at least a part of the transcript to determine whether to poll one or more user devices associated with the communication session for information; when it is determined to poll one or more users of the communication session, generating a poll request based on the transcript; and providing the generated poll request to the one or more user devices of the communication session.

In another aspect, the technology relates to a computer-implemented method for polling user devices associated with a communication session. The method comprises: identifying, as part of the communication session, a user action from a first user device associated with the communication session; generating an entry in a transcript of the communication session based on the user action; analyzing at least a part of the transcript to determine whether to poll one or more user devices associated with the communication session for information; when it is determined to poll one or more user devices of the communication session, generating a poll request based on the transcript; and providing the generated poll request to the one or more user devices of the communication session. In an example, the first user device is a computing device, and wherein identifying the user action from the first user device comprises receiving an indication from the first user device of the user action. In another example, the first user device comprises a sensor, and wherein identifying the user action from the first user device comprises receiving an indication from the first user device of the user action based on sensor input received by the first user device from the sensor. In a further example, providing the generated poll request comprises providing the generated poll request using an electronic conversation agent of the communication session. In yet another example, the analyzing is performed in response to one of: a request from a user device associated with the communication session and determining that a period of time has elapsed. In a further still example, the method further comprises: receiving an analysis request from a second user device, wherein the analysis request comprises a request to analyze the transcript of the communication session; generating, based on the received analysis request, an analysis result for at least a part of the transcript of the communication session; and providing the analysis result as a response to the second user device.

In a further aspect, the technology relates to a computer-implemented method for analyzing a transcript of a communication session. The method comprises: identifying, as part of the communication session, a user action from a first user device associated with the communication session; generating an entry in the transcript of the communication session based on the user action; receiving an analysis request from a second user device, wherein the analysis request comprises a request to analyze the transcript of the communication session; generating, based on the received analysis request, an analysis result for at least a part of the transcript of the communication session; and providing the analysis result as a response to the second user device. In an example, the first user device is a computing device, and wherein identifying the user action from the first user device comprises receiving an indication from the first user device of the user action. In another example, the first user device comprises a sensor, and wherein identifying the user action from the first user device comprises receiving an indication from the first user device of the user action based on sensor input received by the first user device from the sensor. In a further example, generating the entry in the transcript of the communication session comprises: accessing a graph database comprising one or more nodes associated with the communication session; generating a node based on the user action; and generating a relationship between the node and at least one of the one or more nodes. In yet another example, generating the analysis result comprises performing a statistical analysis for the at least part of the transcript. In a further still example, receiving the analysis request comprises receiving the analysis request by an electronic conversation agent of the communication session, and wherein the analysis result is provided by the electronic conversation agent. In another example, the method further comprises: analyzing at least a part of the transcript to determine whether to poll one or more user devices associated with the communication session for information; when it is determined to poll one or more users of the communication session, generating a poll request based on the transcript; and providing the generated poll request to the one or more user devices of the communication session.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
identifying, as part of a communication session, a user action from a first user device associated with the communication session;
generating an entry in a transcript of the communication session based on the user action;
receiving an analysis request from a second user device, wherein the analysis request comprises a request to analyze the transcript of the communication session;
generating, based on the received analysis request, an analysis result for at least a part of the transcript of the communication session; and
providing the analysis result as a response to the second user device.

2. The system of claim 1, wherein the first user device is a computing device, and wherein identifying the user action from the first user device comprises receiving an indication from the first user device of the user action.

3. The system of claim 1, wherein the first user device comprises a sensor, and wherein identifying the user action from the first user device comprises receiving an indication from the first user device of the user action based on sensor input received by the first user device from the sensor.

4. The system of claim 1, wherein generating the entry in the transcript of the communication session comprises:
accessing a graph database comprising one or more nodes associated with the communication session;
generating a node based on the user action; and
generating a relationship between the node and at least one of the one or more nodes.

5. The system of claim 1, wherein generating the analysis result comprises performing a statistical analysis for the at least part of the transcript.

6. The system of claim 1, wherein receiving the analysis request comprises receiving the analysis request by an electronic conversation agent of the communication session, and wherein the analysis result is provided by the electronic conversation agent.

7. The system of claim 1, wherein the set of operations further comprises:
analyzing at least a part of the transcript to determine whether to poll one or more user devices associated with the communication session for information;
when it is determined to poll one or more users of the communication session, generating a poll request based on the transcript; and
providing the generated poll request to the one or more user devices of the communication session.

8. A method for polling user devices associated with a communication session, comprising:
identifying, as part of the communication session, a user action from a first user device associated with the communication session;
generating an entry in a transcript of the communication session based on the user action;
analyzing at least a part of the transcript to determine whether to poll one or more user devices associated with the communication session for information;
when it is determined to poll one or more user devices of the communication session, generating a poll request based on the transcript; and
providing the generated poll request to the one or more user devices of the communication session.

9. The method of claim 8, wherein the first user device is a computing device, and wherein identifying the user action from the first user device comprises receiving an indication from the first user device of the user action.

10. The method of claim 8, wherein the first user device comprises a sensor, and wherein identifying the user action from the first user device comprises receiving an indication from the first user device of the user action based on sensor input received by the first user device from the sensor.

11. The method of claim 8, wherein providing the generated poll request comprises providing the generated poll request using an electronic conversation agent of the communication session.

12. The method of claim 8, wherein the analyzing is performed in response to one of: a request from a user device associated with the communication session and determining that a period of time has elapsed.

13. The method of claim 8, further comprising:
receiving an analysis request from a second user device, wherein the analysis request comprises a request to analyze the transcript of the communication session;
generating, based on the received analysis request, an analysis result for at least a part of the transcript of the communication session; and
providing the analysis result as a response to the second user device.

14. A method for analyzing a transcript of a communication session, comprising:
identifying, as part of the communication session, a user action from a first user device associated with the communication session;
generating an entry in the transcript of the communication session based on the user action;
receiving an analysis request from a second user device, wherein the analysis request comprises a request to analyze the transcript of the communication session;
generating, based on the received analysis request, an analysis result for at least a part of the transcript of the communication session; and
providing the analysis result as a response to the second user device.

15. The method of claim 14, wherein the first user device is a computing device, and wherein identifying the user action from the first user device comprises receiving an indication from the first user device of the user action.

16. The method of claim 14, wherein the first user device comprises a sensor, and wherein identifying the user action from the first user device comprises receiving an indication from the first user device of the user action based on sensor input received by the first user device from the sensor.

17. The method of claim 14, wherein generating the entry in the transcript of the communication session comprises:
accessing a graph database comprising one or more nodes associated with the communication session;
generating a node based on the user action; and
generating a relationship between the node and at least one of the one or more nodes.

18. The method of claim 14, wherein generating the analysis result comprises performing a statistical analysis for the at least part of the transcript.

19. The method of claim 14, wherein receiving the analysis request comprises receiving the analysis request by an electronic conversation agent of the communication session, and wherein the analysis result is provided by the electronic conversation agent.

20. The method of claim 14, further comprising:
analyzing at least a part of the transcript to determine whether to poll one or more user devices associated with the communication session for information;
when it is determined to poll one or more users of the communication session, generating a poll request based on the transcript; and
providing the generated poll request to the one or more user devices of the communication session.
